(19) United States
(12) Patent Application Publication
(10) Pub. No.: US 2013/0339154 A1
(43) Pub. Date: Dec. 19, 2013

(54) SYSTEM AND METHOD FOR ASSEMBLING PERSONALIZED OFFERS

(71) Applicants: Debbie Shimizu, San Jose, CA (US); Farman Syed, San Jose, CA (US); Takahisa Hasegawa, Palo Alto, CA (US)

(72) Inventors: Debbie Shimizu, San Jose, CA (US); Farman Syed, San Jose, CA (US); Takahisa Hasegawa, Palo Alto, CA (US)

(73) Assignee: Apple Inc., Cupertino, CA (US)

(21) Appl. No.: 13/524,502

(22) Filed: Jun. 15, 2012

(51) Int. Cl. G06Q 30/02

(52) U.S. Cl. 705/14.66; 705/14.49

(57) ABSTRACT

System and methods for delivering personalized offers are provided. In particular, based on an identification of a user from a plurality of users associated with a portal, items and inducements for an offer can be generated and delivered to the user. This involves identifying other user associated with the item and the portal and projecting a degree of interest for the user in the item based on similarity data between the plurality of users. The similarity data can be utilized and generated using a collaborative filter engine. Once items and corresponding inducements are identified, a communication can be provided for the user that facilitates access to information regarding the item and the associated inducement.

### 1. TECHNICAL FIELD

The present disclosure relates to personalized offers for users and more specifically to assembling and providing personalized offers for users.

### 2. INTRODUCTION

In general, it is recognized by most sellers that when the price of an item is discounted, permanently or temporarily, the result is generally increased sales for the item. This can be a result of several factors. For example, some consumers may be interested in the item, but for one or more reasons these consumer have a maximum price they are willing to spend on the items. Other consumers may be have significantly less interest in the item, but may be interested in purchasing the item if the price point is significantly low. Yet other consumers may not have had past interest or even knowledge of the item, but may choose to purchase the item upon concurrently learning of the existence of the item and the available discount.

Traditionally, even in electronic media, the advertisement of such discounted items has been typically limited to mass advertising techniques. That is, a seller placing several items for sale will generate some type of advertisement and deliver the advertisement to potential buyers. For example, this advertisement will then be distributed to potential buyers via mass distribution means, such as print media (e.g., direct mailings or Sunday newspaper circulars), email, or other messaging means. Some targeting is possible in some cases. That is, an advertisement campaign can be generated to target segment likely associated with purchasing the sale items from the seller. In some cases, sellers can also examine past purchases of their own customers and thereafter utilize this information to discern when to send the advertisement directly to the user. Alternatively, the seller may setup the seller's website or other interface to include information about sale items or a link thereto.

However, a significant issue with the above-mentioned methods is that they generally fail to account for fail to look beyond the individual buyers' information to project which of the sale items would be of particular interest to the user. Further, from the individual buyers' information, it may be difficult to project whether new, unrelated items would be of interest to the user. Accordingly, an improved method for informing potential buyers of items for sale is needed.

### SUMMARY

Additional features and advantages of the disclosure will be set forth in the description which follows, and in part will be apparent from the description, or can be learned by practice of the herein disclosed principles. The features and advantages of the disclosure can be realized and obtained by means of the instruments and combinations particularly pointed out in the appended claims.

The present technology is directed to system and methods for assembling and providing personalized offers to users. In particular, the present technology leverages information obtained from multiple users to not only identify potential buyers for sale items, but also to identify potential items to place on sale based on known users. Specifically, the present technology identifies user that are currently not associated with an item. This item can be one currently associated with an inducement. Thereafter, a collaborative filter engine can be utilized to generate similarity data for all users associated with the portal to identify whether or not the user is likely to have interest in the item. If the projected interest is high, then the item can be offered to the user with the inducement. In cases where the item is not yet associated with an inducement, the inducement can be computed after an item is identified.

One aspect of the present technology is how to identify users to which items will be offered. One method is to evaluate user interest in items at the time begins to interact with a portal. Alternatively, the portal can actively analyze known users using the similarity data to identify items to offer to users.

Another aspect of the present technology is how the information regarding an offered will be conveyed to users. In some cases, the information can be conveyed as part of an interface associated with the portal. For example, static or dynamic interface elements can be provided to provide the offer or guide the user to the offer. In other cases, the information can be conveyed as part of a message to the user.

The present technology also provides for adjusting which offers will be presented to a user. For example, user preferences can be stored that specific which types of offers should be presented to the user. In another example, device preferences can be stored to specify whether certain offers should be provided to certain types of devices. Other preferences can also be applied to limit or filter the offers provided.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 is a schematic illustration of exemplary software interface 200 for a media portal on personal computer device;

FIG. 3 is a schematic illustration of exemplary software interface 300 for a media portal on mobile device;

FIG. 4 is a flow chart of steps in an exemplary method for delivering personalized content offers for items to users based on detection of a user accessing an interface of a portal associated with the items;

FIG. 5 illustrates an example method embodiment for generating similarity data for media items at a server;

FIGS. 6A and 6B illustrates the concept of representing songs as vectors;

FIG. 7 illustrates and exemplary master purchase matrix;

FIG. 8 illustrates data stored in a master similarity table;

FIG. 9 illustrates an individual similarity table;

FIG. 10 illustrates an exemplary system for carrying out the various methods described herein;

FIG. 11 illustrates a flow chart of steps in an exemplary method for generating a modified interface for a portal based on items identified as being of interest to the user;

FIG. 12 illustrates a flow chart of steps in another exemplary method for generating a modified interface for a portal based on items identified as being of interest to the user;

FIG. 13 is a flow chart of steps in an exemplary method for providing personalized offers to users, where the offers are generated dynamically; and

FIG. 14 is a flow chart of steps in an exemplary method 1400 for automatically presenting personalized offers to users

### DETAILED DESCRIPTION

The present technology is described with reference to the attached figures, wherein like reference numerals are used throughout the figures to designate similar or equivalent elements. The figures are not drawn to scale and they are provided merely to illustrate the present technology. Several aspects of the present technology are described below with reference to example applications for illustration. It should be understood that numerous specific details, relationships, and methods are set forth to provide a full understanding of the present technology. One having ordinary skill in the relevant art, however, will readily recognize that the present technology can be practiced without one or more of the specific details or with other methods. In other instances, well-known structures or operations are not shown in detail to avoid obscuring the present technology. The present technology is not limited by the illustrated ordering of acts or events, as some acts may occur in different orders and/or concurrently with other acts or events. Furthermore, not all illustrated acts or events are required to implement a methodology in accordance with the present technology.

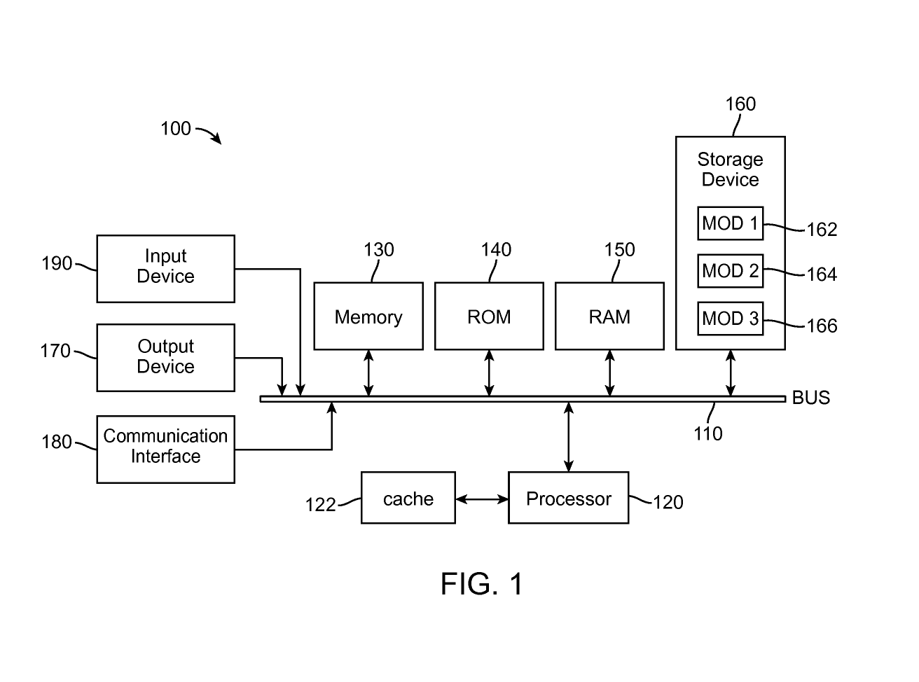

FIG. 1 illustrates an exemplary system 100 that includes a general-purpose computing device 100, including a processing unit (CPU or processor) 120 and a system bus 110 that couples various system components including the system memory 130, such as read only memory (ROM) 140, and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs a hard disk as storage device 160, it should be appreciated by those skilled in the art that other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules MOD1 162, MOD2 164 and MOD3 166, which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now turns to further details regarding the present technology. As described above, the present technology is directed to systems and methods for providing personalized content offers to users. In particular, the present technology provides a methodology for identifying items that would likely be of interest to the user, based on similarity data, and thereafter forwarding or providing the user an offer for the items. This offer can include an inducement to entice the user to purchase the item. As used herein, the term “inducement” refers to any type of financial or non-financial consideration included as part of an offer for an item intended to make the purchase of the item more attractive to the potential buyer, relative to its normal cost. For example, this can include a discounted price on the item or a discounted price on another item or service.

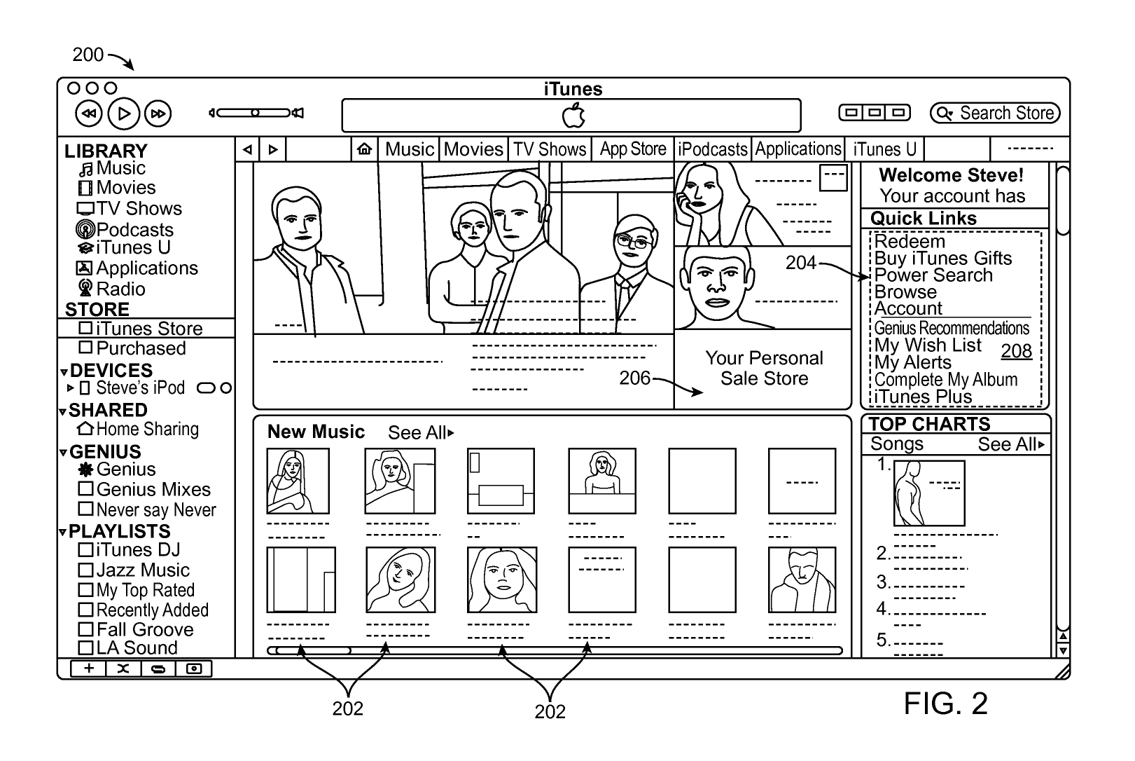

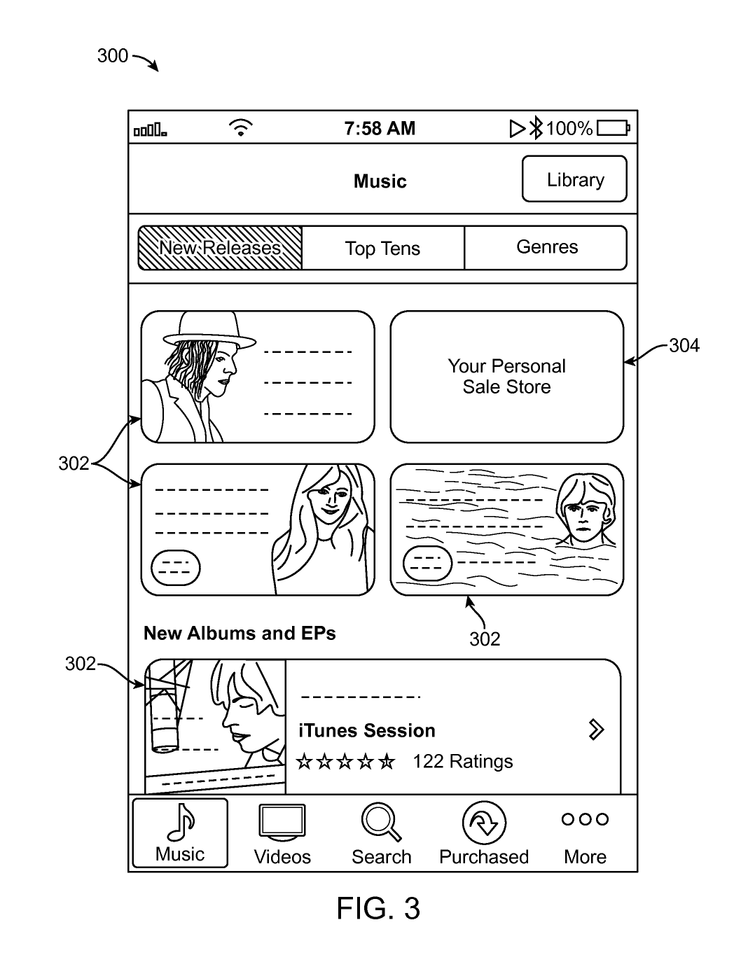

In the present technology, the items for the offer and the inducement can be determined upon identification of a user or can be determined prior to identification of a user. The offer can then be delivered to the user via a messaging means, such as email or text messaging, or can be displayed at an interface associated with the seller's portal and the user. Examples of the latter are illustrated in FIGS. 2 and 3. As used herein, the term “portal” refers to any type of interface that provides users at computing device access to goods, resources, or services. Such goods, resources, and services include, but are not limited to, e-mail, web sites, forums, search engines, online shopping, databases, applications, and systems linked to the interface. Further, such interfaces can be implemented in a variety of ways. For example, such interfaces can be implemented using a standalone application at a user's computing device, a web site delivered to a user's web browser, or any other type of interface system or application at the user's computing device.

FIG. 2 is a schematic illustration of exemplary software interface 200 for a media portal on personal computing device. Interface 200 can include a plurality of interface elements 202 and other links 204 for purchasing items or viewing items offered by the portal. These interface elements 202 buttons, drop-down lists, or any other type of interface elements. In general, the interface elements 202 and the links 204 will generally be the same from user to user. However, the present technology provides for modifying the interface elements 202, the links 204, or both, to provide content offers personalized for the user. For example, one of the elements of the interface 200, such as element 206, can provide a means for the user to view or access the personalized offers. For example, the element 206 can direct the user to a location to view the offers or explicitly present the offers and allow the user to purchase the item. Similarly, one of links 204, such as link 208, can provide a means for the user to view personalized offers.

A similar interface can be provided on a mobile device, as illustrated in FIG. 3. FIG. 3 is a schematic illustration of exemplary software interface 300 for a media portal on mobile device. Interface 300 can include a plurality of interface elements 302 for purchasing items or viewing items offered by the portal. These interface elements 302 buttons, drop-down lists, or any other type of interface elements. In general, the interface elements 302 will generally be the same from user to user. However, the present technology provides for modifying the interface elements 302 to provide content offers personalized for the user. For example, one of elements 302, such as element 304, can provide a means for the user to view personalized offers. Alternatively element 304 can present the offer itself and allow the user to purchase the item.

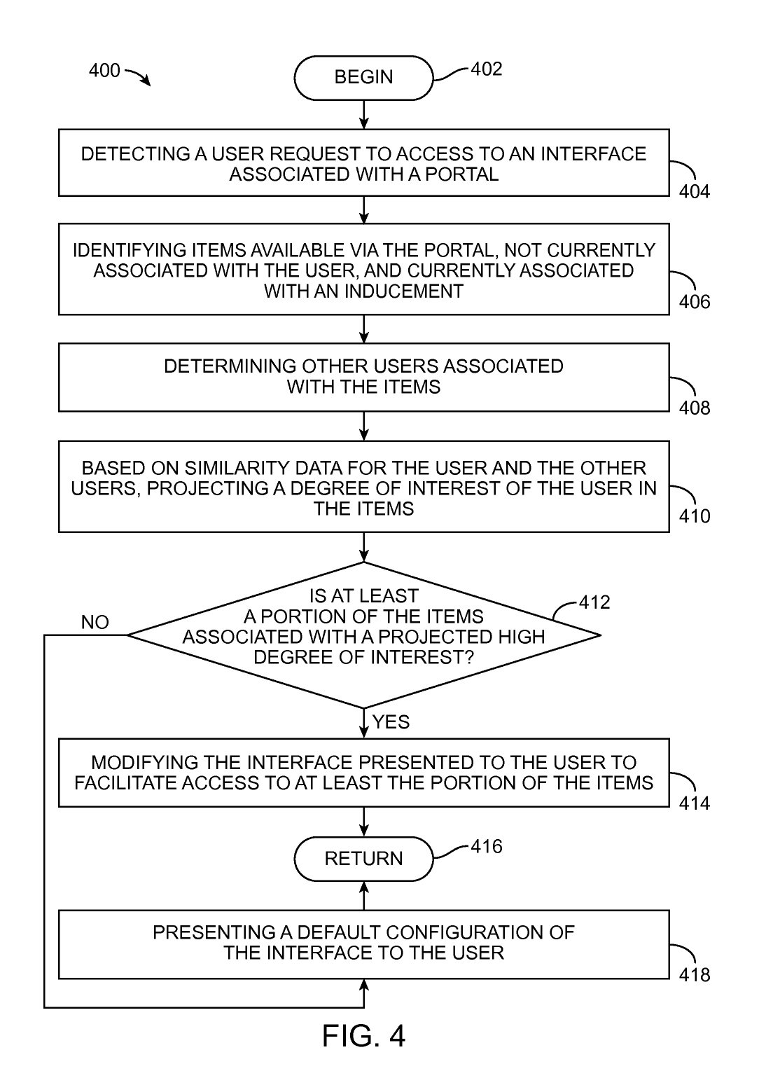

Now that a general description of the present technology has been provided, the disclosure now turns to a description of various methodologies associated with the present technology. A first of the methodologies is described below with respect to FIG. 4.

FIG. 4 is a flow chart of steps in an exemplary method 400 for delivering personalized content offers for items to users based on detection of a user accessing an interface of a portal associated with the items. The method 400 begins at step 402 and then proceeds to step 404. At step 404, a request from a user to access an interface associated with a portal is detected. For example, step 404 can involve the user initializing an application associated with the portal. Alternatively, step 404 can involve the user logging into a website or other interface associated with the portal. Additionally, any other communications between the user and the portal can also be interpreted as a request to access an interface of the portal.

Responsive to the detection at step 404, the portal can identify items at step 406 that are currently associated with an inducement and not currently associated with the user. Once such items are identified at step 406, the method 400 can proceed to step 408 to begin the generating of the personalized offer. In particular, at step 408, the portal can identify other users currently associated with the identified items. For example, the portal can identify all other users that have purchased the items identified at step 406.

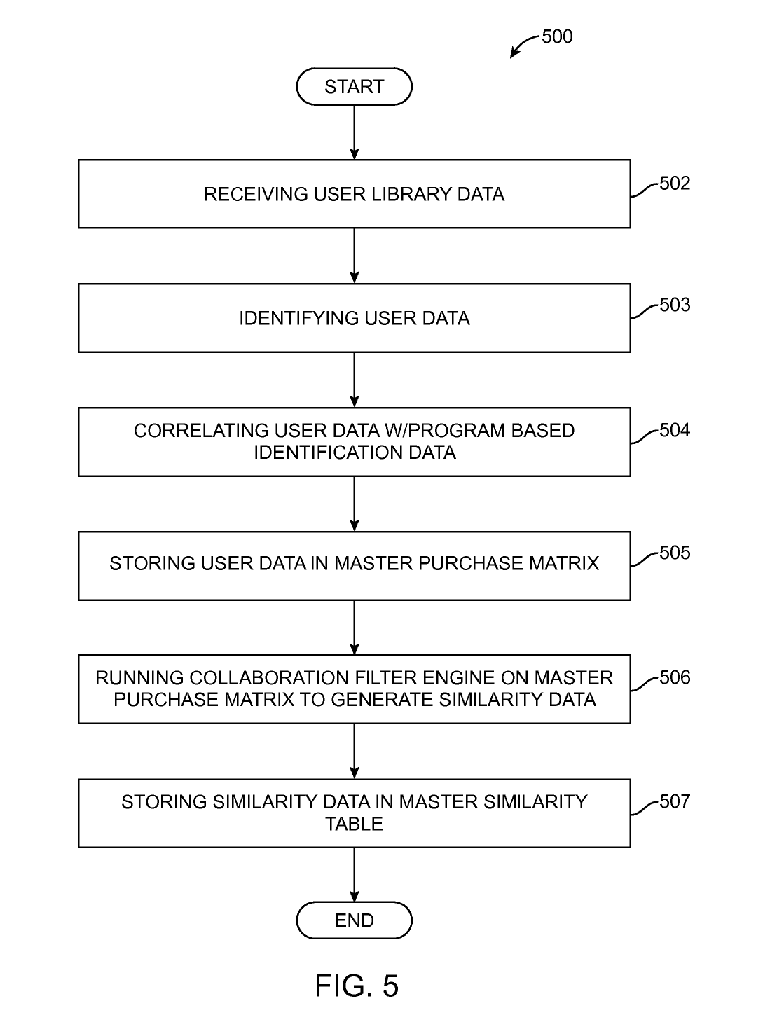

Once other users associated with the items are identified at step 408, the method 400 can proceed to step 410. At step 410, similarity data for the user and the other users is utilized to project the degree of interest of the user in the various items identified at step 406. This can include computing a score, a ranking, or any other measure of the likely interest of each item to the user. An exemplary methodology for determining the degree of interest in items is described in further detail below with respect to FIGS. 5-10. Thereafter, if there is a high degree of interest in a portion of the items (412), method 400 proceeds to step 414. At step 414, the interface for the user can be modified to facilitate access to the portion of the items. For example, as described above with respect to FIGS. 2 and 3, interface elements can be added or modified to allow the user to view information regarding the items or purchase the items. The method 400 can then proceed to step 416 and resume previous processing, including repeating and of the methods described herein. In the event that no items are projected to be of sufficiently high interest to the user at step 412, the method can instead proceed to step 418, where the default configuration for the interface is presented to the user. The method 400 can then proceed to step 416 and resume previous processing, including repeating and of the methods described herein.

It is worth noting that the present technology contemplates that the interface can be updated dynamically. For example, as the information associated with different users changes over time, the similarity data may change. As a result, the items that should be presented to the user can be changed to reflect such changes. In another example, the inducements can be configured to be valid for only a limited amount of time. Thus, once the time for the inducement expires, the items that should be presented to the user can be changed to reflect such changes. In still another example, the present disclosure contemplates that when a group of items is available for a user, not all items will necessarily be presented contemporaneously. That is, the interface element provided to modify the default configuration of the interface can be adapted to present only a limited number of the items and change the items in the presented interface element over time.

As described above with respect to step 410, one aspect of the present technology is the use of similarity data to determine which items should be presented to a user. The methodology for the generating and use of such similarity data is described below with respect to FIGS. 5-10. For ease of illustration, the discussion below will be directed to similarity data associated with media items. However, the present technology is not limited in this regard and the methods described below are equally application to identifying any type of goods or services based on similarity data.

FIG. 5 illustrates an example method 500 for generating similarity data for media items at a server. The method includes receiving by the server, user data related to program participants' personal media inventory (502). The user data comprises identifying information regarding individual media items in a user's library usually in the form of metadata. The origin of the media items within a user's library is not relevant to the system. Even if the method described is employed by a music content store, the present embodiment does not require that a user's files originate from the music store since the server does not differentiate between file information based on source—all media items are treated the same. The method applies equally to physical media, such as software, music, or video content on physical media, as well as instances where the content on the physical media is transcoded to digital format and entered into the user's media library. In some configurations, the server does not require that a user uploads information regarding all media items in their library; information regarding only a limited number of media items or only partial information about the media items is also accepted by the server.

The method also includes identifying the user data as specific media items 503. This step may be accomplished in any one of a number of ways including examining the file name, metadata or through a detailed analysis of a portion of the file. In the example of a music track, the server can identify the music track through a variety of mechanisms. For example, a given track such as Led Zeppelin's Stairway to Heaven having a length of approximately eight minutes can have a variety of data associated with the file including the file name or metadata identifying the artist, song name, genre, length of track, album name, track number, etc. A portion of this data can be sufficient for the server to identify the file as Led Zeppelin's Stairway to Heaven from the album Led Zeppelin IV. Alternatively, commercial song identification services can be used to identify the file. It is also possible to identify the track by sampling a portion of the music track or by recognizing a unique identifier from a purchasing store or by recognizing the songs digital fingerprint. For example, the server or service can recognize that a song was bought from a particular content portal and the file's metadata contains a unique identifier specific to the particular content portal. The server can identify the media item by that identifier. It should be appreciated that many other possible methods of recognizing media items are well known and all of which are encompassed by the disclosed method and arrangement.

Once the information for the media items is obtained, as described above, each media item can be associated with a unique identifier in step 504 and stored in a table in step 505. If the server has never encountered the song before, the server assigns a new identifier to that track. However, for most media items, an identifier will already be assigned and media need only be correlated with that identifier. Continuing with the example of Stairway to Heaven, once the media item has been identified as that track, the server can look up the unique identification data for that track. This process is repeated for each media item received by the server.

Although the server will already have an identifier to associate with most songs, in some cases, the media item will be completely new to the server, or at least recognized as such. In these cases, the server will issue a new identifier and assign it to that media item. For example, a new artist or garage band might not be recognized by the server. However, the server will issue a new identifier for that artist's track and when the server encounters the same track in a different user's library; it will assign the same identifier to that track as was previously issued.

In some cases, the server might not supply a new identifier to a media item that is new to the server. For example, a media item might be unique to a user's library and therefore providing an identifier would not be of any value since there would be no incidences of co-occurrence for that item. Accordingly, the system need not supply a unique identifier to all new items. Later, the system can supply a unique identifier for that track and supply similarity data for that item if and when other users also have that media item in their libraries.

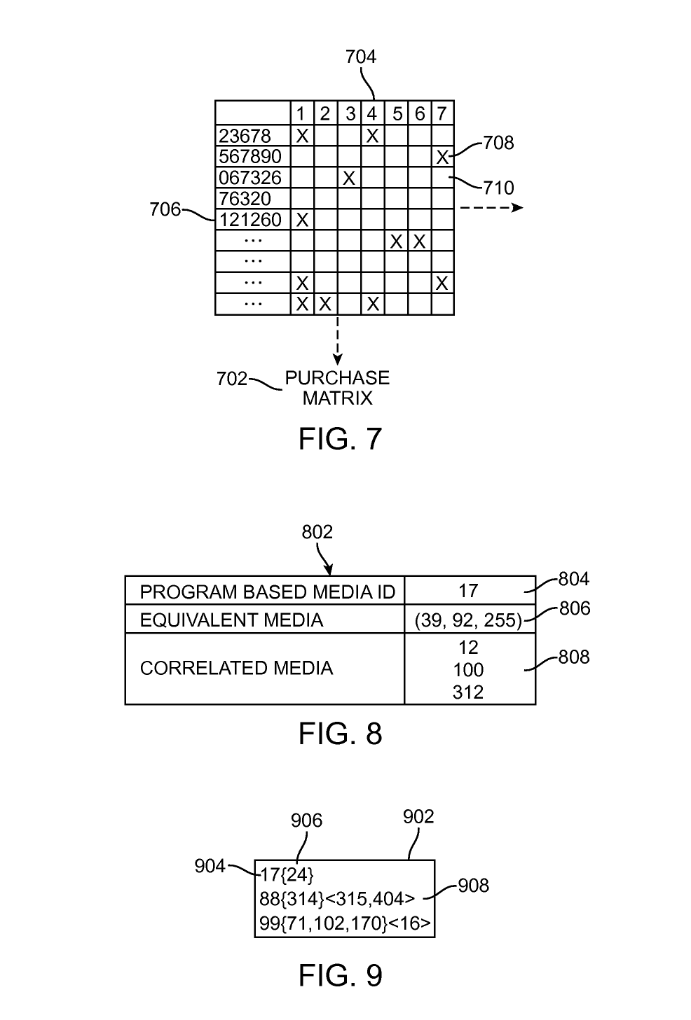

Each media item is stored in a master purchase matrix in step 505. An illustration of the master purchase matrix is shown in FIG. 7. The purchase matrix 702 is a table that contains columns 704 corresponding to each unique media item in the table. In the embodiment wherein the table is hosted by a music content seller, the purchase matrix will also include all media items available for purchase from the music content seller. The rows of the master purchase matrix 704 are associated with user unique user identification numbers 706. This identification code represents users by an anonymous identification code possibly known to the user, not the system. Thus the master purchase matrix contains a record of every file received by the program server from every user that participates.

As the purchase matrix accommodates all program participants and all media in each program participant's library, the purchase matrix 702 is likely to be staggeringly large. For example, if a music store has approximately 13.25 million users and more than 5 million songs. A purchase matrix for such an online store would be a table of approximately 13.25 million rows and 5 million columns, or 1,125 billion individual cells. A purchase matrix for such an online store with 50 million registered users and contains over 10 million songs would be a table of approximately 50 million rows and 10 million columns, or 500,000 billion individual cells.

For songs in a user's library, the cell in the matrix corresponding to that user and that song is marked. The marking may be done with a data type as simple as a Boolean, 1 for purchased 708 and 0 for not purchased 710. Other data types may be used when more data must be stored than a Boolean data type will allow. While the matrix can be very large, it is very sparsely populated because most users have relatively few songs (compared to 5 million) in their library. Each user row may only contain a handful of entries while each song column may contain tens, hundreds, thousands, or even millions of entries for more popular songs, but the vast majority of the purchase matrix is empty.

It should also be appreciated that the master purchase matrix or table will require updating as user libraries change, from adding new songs to their library, changing file metadata, or deleting files. The purchase matrix may be updated in real time or transactions may be queued up for insertion at a later date. One arrangement for queuing inserts transactions into the purchase matrix on a regular basis, such as every day at 11:30 p.m. Another queuing arrangement inserts transactions into the purchase matrix when some minimum number of transactions is ready for insertion.

Updates to the purchase table do not require repeating steps 503 and 504 for all media items. Media items that have already been identified and correlated to a program-based identification number do not require the identification and correlation step because it has already been performed when the user's data initially populated the table. In one embodiment, once the server has correlated the media item to its identification data, the server can send the identification data back to the user for storage in metadata. In future communications with the server, the server can receive updates to a media item with the associated identification data thus avoiding the need to redo step 504.

In some embodiments the purchase matrix may be part of a larger table or matrix including additional information regarding each transaction such as time and date of sale, what format the media is in, whether the media is high definition or standard definition, whether the transaction is a gift or whether it was paid for, which devices are authorized for playback, etc. The purchase matrix may be discrete, separate tables or may be wholly integrated into a larger table or matrix.

In still yet another embodiment, the master purchase matrix need not contain uploaded information about a user's media inventory. The master purchase matrix can be essentially comprised of purchase information. Purchase information can be only items purchased from the online store by users or can include additional information. In this embodiment the table can contain a list of all items purchased by each user. Still, the master purchase matrix would likely contain at least a limited set of similarity data regarding the content of a user's media inventory.

After steps 504 and 505, the method illustrated in FIG. 5 next comprises running a calibration filter engine on the master purchase matrix to generate similarity data in step 506 and store the similarity data in a master similarity table in step 507. Similarity data can be derived from a media item's incidence of co-occurrence with some other media item in the master table. When users have the same two media items, they are said to co-occur. Such co-occurrence in multiple users' libraries is an indication that the two media items are “similar.” The more often two media items co-occur in program participants' libraries, the more similar the media items are said to be.

A collaborative filter engine can be used to calculate the similarity between individual media items in the master purchase table. In one embodiment the collaborative filter engine can be as simple as a program that tallies the number of times pairs of songs in the database co-occur in the program participants' libraries.

In one embodiment, the collaborative filter engine can calculate the similarity between two different media items by representing each item as a vector in a multidimensional vector space. The number of dimensions is equal to the number of users in the purchase matrix. A correlation between items is developed by computing the distance between vectors. A pure or modified trigonometric function (e.g. cosine or sine function) can be used to calculate the distance between vectors. If the two vectors have a small angle, they are considered to be similar and if the two vectors have a large angle, they are considered to be less similar. This process is carried out by comparing each song in the master purchase matrix to every other song in the master purchase matrix.

In another embodiment the collaborative filter engine can take into account more than the incidence of co-occurrence data. For instance, the incidence of overall occurrence can be factored into the similarity rating. For example, songs A and B may co-occur equally as often as songs A and C, but songs A and B can have a higher similarity score (that is, deemed more similar) than songs A and C if song B is more popular overall. One way of determining the popularity of the different songs is by measuring how often each song occurs in the overall data set.

Likewise there can be other inputs into the collaborative filter engine which affect similarity scores, such as usage inputs. For example, ratings given to the media items, play counts, and skip counts can all be inputs into the collaborative filter engine for determining similarity between media items.

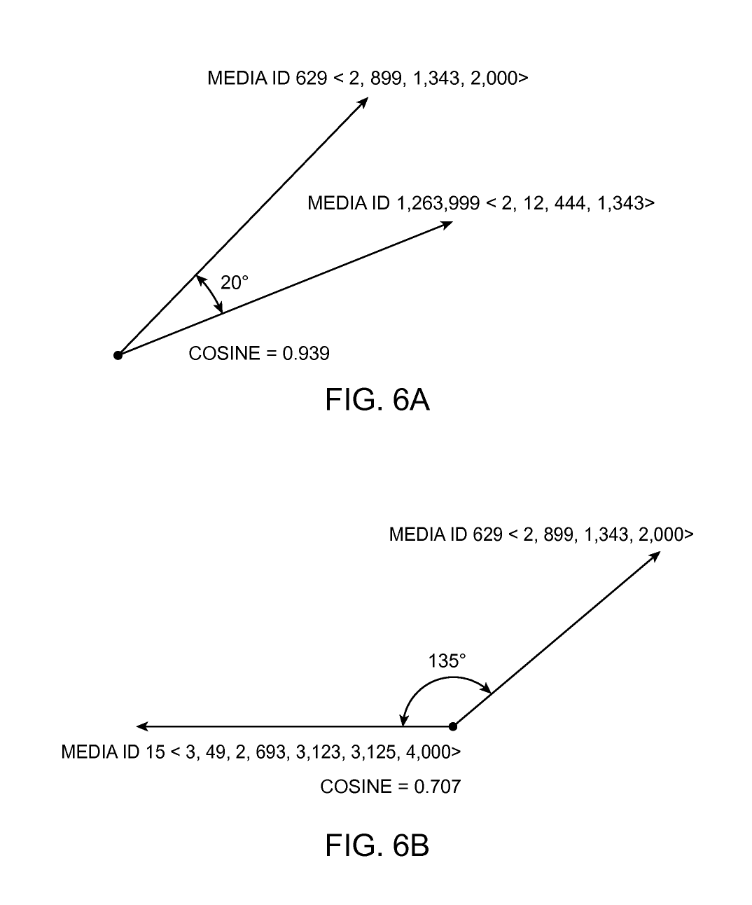

FIGS. 6A and 6B illustrate the concept of representing each song as a vector. In FIG. 6A, a vector for Media ID 629 in the master table has been mapped out based on the songs existence in the libraries of users 2, 899, 1,343 and 2,000. Likewise, a vector has been mapped for Media ID 1,263,999 in the master table based on the song's existence in the libraries of users 2, 12, 444, 1,343. The angle between these two vectors is measured to be twenty degrees and calculates to a cosine value of approximately 0.939. The cosine value represents the correlation value between Media ID 629 and Media ID 1,263,999. FIG. 6B represents another correlation calculation to determine the correlation between Media ID 629 and Media ID 15. In this example, no users have both Media ID 629 and Media ID 1,263,999 in their libraries and therefore the cosine value between these two vectors is approximately 0.707. The lower score indicates that Media IDs 629 and 1,263,999 are not closely correlated to each other.

In another embodiment, other functions can be used to calculate the similarity scores between items. By way of example the similarity score can be calculated in a method that takes into account the percentage of an item's total co-occurrences that is made up by a particular item. For example item A co-occurs with items 1-5 and the item A's total co-occurrences is the sum of all the co-occurrences with items 1-5. For instance, if item A co-occurs with item 1 two times, item 13 two times, item 3, two times, item 4 ten times, and item 5 two times, then item A has 18 total co-occurrences. It can be valuable to learn what percentage of the total number of co-occurrences is due to a particular pair. For example, item 4 represents approximately 55% of all of item A's co-occurrences and therefore is more strongly correlated with item A than any of the other items which represent only about 11% each of the total of A's co-occurrences. This data can also be used to determine similarity data. Although two specific methods of calculating similarity data are illustrated above, it will be appreciated that any number of other methods of calculating the similarity between two items can be used.

The process above is computed between every item and every other item at some regular interval. As this process could take inordinate amounts of time, it is typically performed offline. It could be performed once a month, once a week, once a day, or as frequently as computing capability allows.

The correlation data compiled by the collaborative filter engine is used to generate a master similarity table in step 507 of FIG. 5. FIG. 8 illustrates data stored in a master similarity table 802. For a given media item, there is an entry in the master similarity table identifying the media item by its program-based identification data 804. Each other media item considered to be similar or correlated to that media item is also listed in the table 808. In this way the table 802 maintains a list of all media that is similar to each media item in the master purchase matrix 702.

Items are included in the master similarity table if they have a sufficient score to be considered similar or correlated to the media item. For any given item, most of the other items are not similar at all. When the similarity score is sufficiently low, it is not included in the similarity table. The threshold for determining if a similarity score is sufficiently low or high may be dynamic or static. For example, if a similarity score ranges from −1 to 1, −1 being completely dissimilar and 1 being extremely similar, the threshold may be statically set to 0.5. The threshold may be dynamically set based on the number of occurrences of the song in the master purchase table, such as a threshold of 0.9 for songs occurring under 100 times, 0.7 for songs occurring under 5,000 times, 0.6 for songs occurring under 135,000 times, and 0.5 for songs occurring 135,000 times or more. The threshold may also be based on available storage or any other parameter.

In other words, the master similarity table 802 may incorporate all or some of the similarity scores. If the master similarity table must be constrained to fit a certain storage size, then only the best or strongest similarities are included and the rest are culled out. Similarly, if not enough program participants have an item in their media inventory, it could be excluded. One variation on this is to require a minimum number of occurrences in users' libraries before an item is eligible for inclusion into the master similarity table. For example, if two items have a co-occurrence of five or less, i.e. if five or less people have both of these items, the system does not compute the rest of the score.

In another embodiment the master similarity table can also store equivalency relationships. For example, media ID 17 in table 802 may correspond to “0 Sole Mio” by Luciano Pavarotti, as performed in 1990. Multiple renditions of “O Sole Mio” by artists such as Enrico Caruso and Mario Lanza are available in the online store and are considered equivalent media 806. Other notable types of equivalent media include official album tracks, unplugged acoustic tracks, live concert tracks, cover tracks by other bands, and even foreign language tracks of the same song. A single song may exist in all the listed forms, and more. The determination of equivalency can be performed by hand or can be automatically performed based on the actual media content, metadata, and/or other available data. Equivalent media IDs for each are presented alongside the media ID 804 to identify that each of them is considered the same and that they are counted together.

The IDs in the master similarity table may be the same as those used in the purchase matrix to index media or they may be based on an entirely different scheme. If the two do not align, a translator function or reference translation table can be provided to convert one ID to the other and vice versa. A common ID space shared between the two is likely to be the easiest and simplest to maintain without a performance penalty.

Although the master similarity table contains the universe of similar media, a personal media library is almost certain to include a lesser subset of that universe of similar media. Thus, a constrained set, or an individual similarity table, is generated. The constraint is tailored to media availability in a given library. The constrained set may also include references to similar media not found in the media library. This can be done in order to target suggested media purchases to a user. Such targeted suggested purchases are likely to be more appealing to the user because other people with some common media tastes already have the suggested purchase in their library.

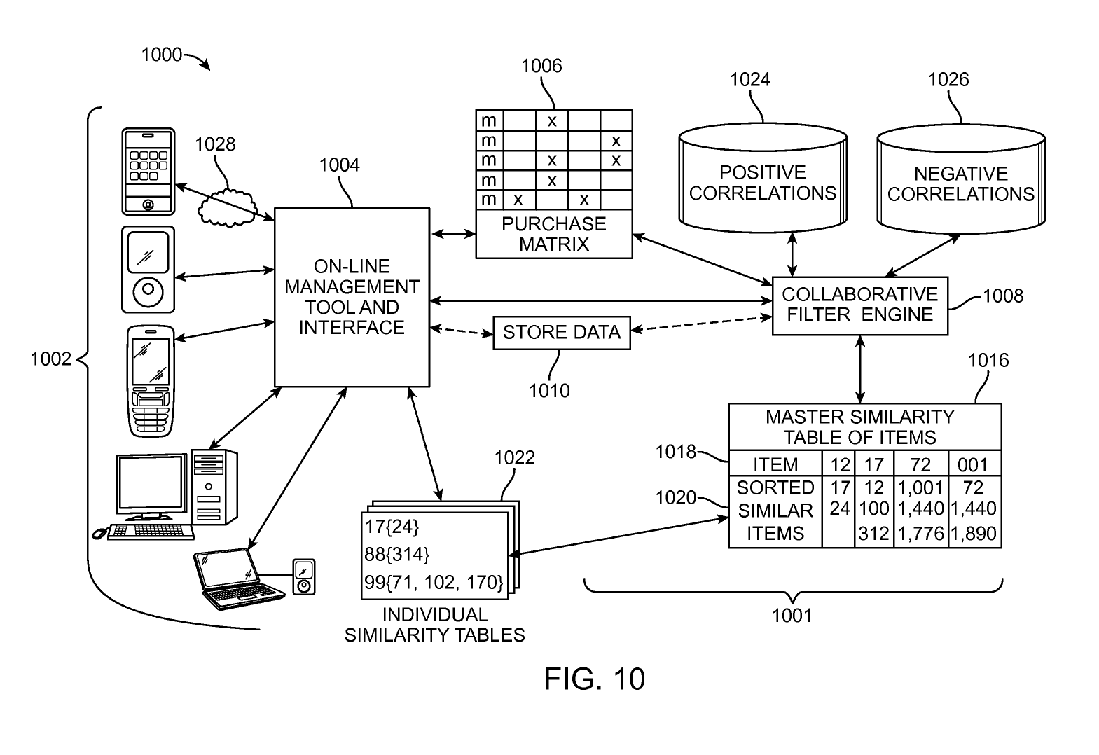

Once the master similarity table 802 is calculated and populated, individual similarity tables 902 are generated. FIG. 9 illustrates an individual similarity table. An individual similarity table 902 contains a media ID 904 for each song contained in the individual's media library and media correlated to that media ID. Correlated media 906 are shown in braces. Correlated media in an individual similarity table are a subset of the entire list of sorted similar items 908 located in the master similarity table of items. The subset is selected based on which media are present in the individual's media library. In other words, for each song in the individual's library, a list of similar media also contained in the individual's library is generated.

Individual similarity tables can be generated by the server at the server and downloaded by client devices or individual similarity tables can be created by the client by downloading only similarity data for items in the user's media inventory. Regardless of where the similarity tables are created, the process is the same. Media items are looked up in the master similarity table by that items program-based similarity identification data. Next the system can lookup the location of the similarity data for that media item in an index. Based on the results of the lookup operations, the system can retrieve the similar items. These items are further compared with those media items in a user's media library and only those items that are present in the user's media library are stored in the individual similarity table. In an additional, embodiment some highly similar tracks could also be recorded in the individual similarity table to be used for suggesting purchases to the user.

In one configuration, at least one individual similarity table per library can be generated by the server. The client can send the library data to the server, which can identify the items in the library and generate the individual similarity table for that library by extracting the similarity data from the master similarity table pertaining to the items in that library. The resulting individual similarity table can then be downloaded to the client for use in generating playlists. The same individual similarity table can also be used by the client to create individual similarity tables for peripheral devices.

Using these individual similarity tables, the portal can benefit from data derived from the entire population of users. In particular, the portal can use the similarity data to suggest new media purchases and a variety of other possibilities.

In some configurations, users can provide or the portal can require feedback on purchases. That is, feedback indicating users skipping songs that they do not want to hear or positive ratings to media items that they have purchased. Such data can be uploaded from the client devices and received by the server. Feedback data can be stored in any number of different modes such as in the master purchasing index or in separate tables. Feedback can also be derived from online music stores. In this embodiment, user activity on the online store generates feedback data. User activity on the online store can include: purchasing media items, previewing media items, searching for a particular media item title, searching for a particular media item artist or searching for a particular media item genre. Feedback data can be used by the collaborative filter engine to modify correlation scores between items.

Feedback data from the population could potentially eliminate a correlation that otherwise exists. For example, the song Mrs. Robinson by Simon and Garfunkel may receive a strong correlation to the same song by the Lemonheads or Frank Sinatra, but users intending to generate a playlist based on the Simon and Garfunkel version might not like the different versions—perhaps due to the different genres of the cover songs. Over time, feedback data such as skipping the song or removing the item from the playlist could be used to eliminate one or both cover versions from the list of correlated items.

In other embodiments user feedback can also be used to modify similarity data directly on the client without sending the feedback to the server first for use by the collaborative filter engine. In these embodiments, user feedback data can directly affect the relationships stored in the individual similarity table on the client device without first synching with the server. Alternatively, the similarity table can remain the same, but constraints can be generated based on user feedback data. For example, if a user skips a similar item often, the client itself can either no longer consider that item as similar by removing the item from the individual similarity table or can prevent the addition of the frequently skipped item from inclusion in the playlist by other means, such as a constraint in the playlist algorithm.

Over time, new media items can be added to the online store, and by extension to the master purchase table, as artists create new music and new artists emerge. Accordingly, a correlation between existing items in the online store and newly added items in the online store may form. For example, if a user has Song A in his/her media library and subsequently purchases a newly added Song B that was recently introduced on the online store 304, then a new correlation between Song A and newly added Song B may form. When a user purchases newly added Song B, the transaction is recorded in the purchase matrix and an updated purchase matrix is generated. Alternatively, Song B may have been added to a user's library by copying the track from a CD. In such a circumstance, the result would be the same. As long as both Song A and Song B are in the user's media library, this co-occurrence is recorded in the updated master purchase matrix.

The collaborative filter engine uses information from the updated purchase matrix to generate an updated master similarity table of items as described above. Thereafter an updated individual similarity table can be generated for each user by extracting only those items in the updated master similarity table which have been changed. Alternatively an entirely new individual similarity table can be created based on the new data.

FIG. 10 illustrates an example of one such system 1000 that can carry out the embodiments described above. Purchase Matrix 1006 stores data regarding all media items from each user's library. The collaborative filter engine 1008 uses the data in the purchase matrix 1006 to determine the incidence of co-occurrence of each media item relative to each of the others. The collaborative filter engine 1008 can optionally use feedback data stored in objects 1024 and 1026 to adjust similarity scores according to user preference across the population of program participants. The output of the collaborative filter engine is stored in the master similarity table by storing all media items that are deemed similar 1020 to a given media item 1018. The similar media items 1020 can be sorted to be presented in order from the most correlated items to the least correlated.

The on-line management tool 1004 serves as the interface for the client side 1002 and the server side 1001 via communications link 1028. In one configuration, the on-line management tool 1004 can be associated with an on-line store. In one embodiment, the on-line store may generate data 1010 which can also be used by the collaborative filter engine 1008 in generating similarity data. Regardless, the client 1002 serves to both upload information regarding the media items stored on a client 1002 and to download similarity data from the server 1001. Similarity data specific to the client may be downloaded through the on-line management tool 1004 directly from the master similarity table 1016 to generate an individual similarity table 1022 on the client device 1002 or the individual similarity table may be generated by the server 1001 and downloaded to the client device 1002. The client device can also communicate feedback data through the on-line management tool 1004 to the collaborative filter 1008 to aid in generating better similarity data.

It is worth noting that the exemplary configuration of FIGS. 5-10 is but one methodology and system for obtaining and utilizing similarity date. The present technology contemplates that various other methods for obtaining and using similarity data can also be utilized.

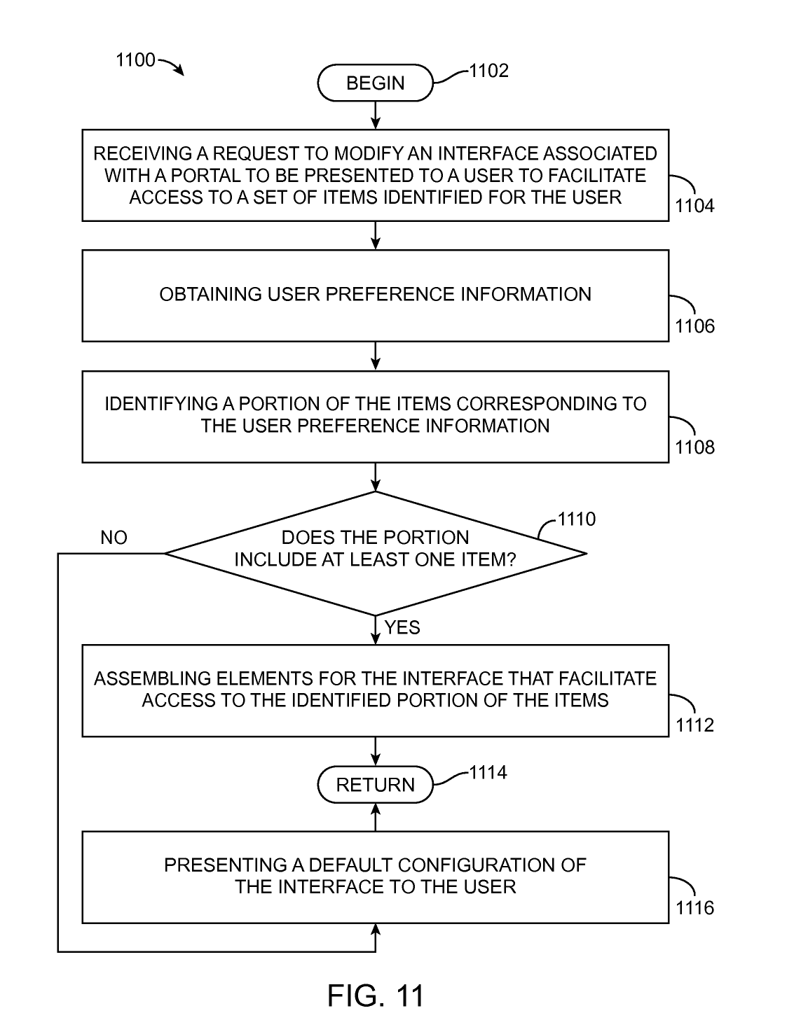

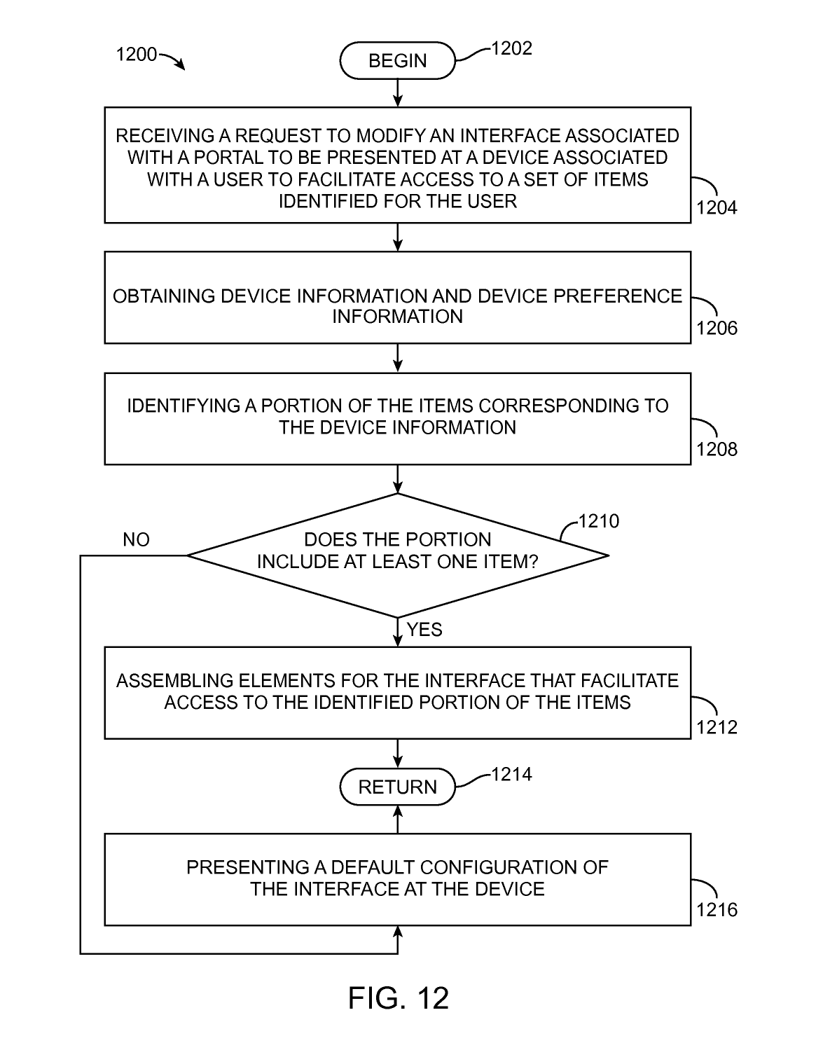

Referring back to FIG. 4, step 414 involves modifying the interface for the portal to facilitate access to the portion of the items identified as projected to be of interest to the user. In one configuration, this results in all identified items being presented. However, in some configurations, the number of items can be adjusted based on other factors. This is illustrated below with respect to FIGS. 11 and 12.

Turning first to FIG. 11, there is shown a flow chart of an exemplary method 1100 for generating a modified interface for a portal based on items identified as being of interest to the user. For example, method 1100 can be performed at step 414 of FIG. 4. The method 1100 begins at step 1102 and proceeds to step 1104. At step 1104, a request to modify the interface is received. In particular, a request to modify the interface to facilitate access to the items identified for the user. Responsive to such a request, user preference information can be obtained at step 1106. This information can be information regarding user preferences for items or presentation thereof. In one configuration, this can be information associated with the portal and can be retrieved from the portal's own systems. However, the present technology is not limited in this regard. In other configurations, the user preference information can be stored at a user device or even in a third party location. In still other configuration, the user preference information can be obtained from multiple sources, including the portal, the user, and third party sources.

Once the user preference information is obtained at step 1106, the method 1100 can proceed to step 1108. At step 1108, the items specified in the request can be compared to the user preference information to identify whether at least a portion of the items can be presented to the user. For example, the user preference information can specify that the user is not interested in specific items, particular types of items, items associated with a particular price range, items associated with a particular source or brand, etc. . . . That is, the user preference information can be used to filter the items specified in the request to identify those that meet the requirements set forth in the user preferences. Thereafter, at step 1110, if at least a portion of the items from the request correspond to the user preferences, the method can proceed to step 1112. At step 1112, the elements needed to modify the user interface can then be generated based on the identified portion from step 1108. The method can then resume previous processing at step 1114, such as presenting the interface to the user.

The present disclosure contemplates that in some instances, the comparison and identification at step 1108 can result in none of the items from the request being suitable for presentation to the user. Accordingly, in such cases method 1100 would instead proceed from step 1110 to step 1116. At step 1116, the interface would be configured for providing a default presentation. The method can then resume previous processing at step 1114, such as presenting the interface to the user.

The present disclosure also contemplates that there can be non-user specific preferences that can affect which items are presented to the user. For example, particular items can be inappropriate for certain types of devices, communications link types, etc. . . . In such configurations, the preferences can apply a filtering as well. This is illustrated below with respect to FIG. 12.

In FIG. 12, there is shown a flow chart of an exemplary method 1200 for generating a modified interface for a portal based on items identified as being of interest to the user. For example, method 1200 can be performed at step 414 of FIG. 4. The method 1200 begins at step 1202 and proceeds to step 1204. At step 1204, a request to modify the interface is received. In particular, a request to modify the interface to facilitate access to the items identified for the user. Responsive to such a request, device information and device preference information can be obtained at step 1206. This device information can be information regarding device type, the current type of communications link, software version information, or any other type of information associated with the user's device. The device preference information can specify rules for particular items. For example, the device preference information can specify that for a device with limited storage or bandwidth capabilities, larger media items may not be appropriate. In one configuration, the information obtained at step 1206 can be stored at the portal and can be retrieved from the portal's own systems. However, the present technology is not limited in this regard. In other configurations, this information can be stored at a user device or even in a third party location. In still other configurations, the information can be obtained at step 1206 from multiple sources, including the portal, the user, and third party sources.

Once the necessary information is obtained at step 1206, the method 1200 can proceed to step 1208. At step 1208, the appropriate rules from the device preference information can be selected based on the device information and the items specified in the request can be compared to rules to identify any portion of the items that can be presented to the user. Thereafter, at step 1210, if at least a portion of the items from the request correspond to the user preferences, the method can proceed to step 1212. At step 1212, the elements needed to modify the user interface can then be generated based on the identified portion from step 1208. The method can then resume previous processing at step 1214, such as presenting the interface to the user.

The present disclosure contemplates that in some instances, the processing at step 1208 can result in none of the items from the request being suitable for presentation to the user. Accordingly, in such cases method 1200 would instead proceed from step 1210 to step 1216. At step 1216, the interface would be configured for providing a default presentation. The method can then resume previous processing at step 1214, such as presenting the interface to the user.

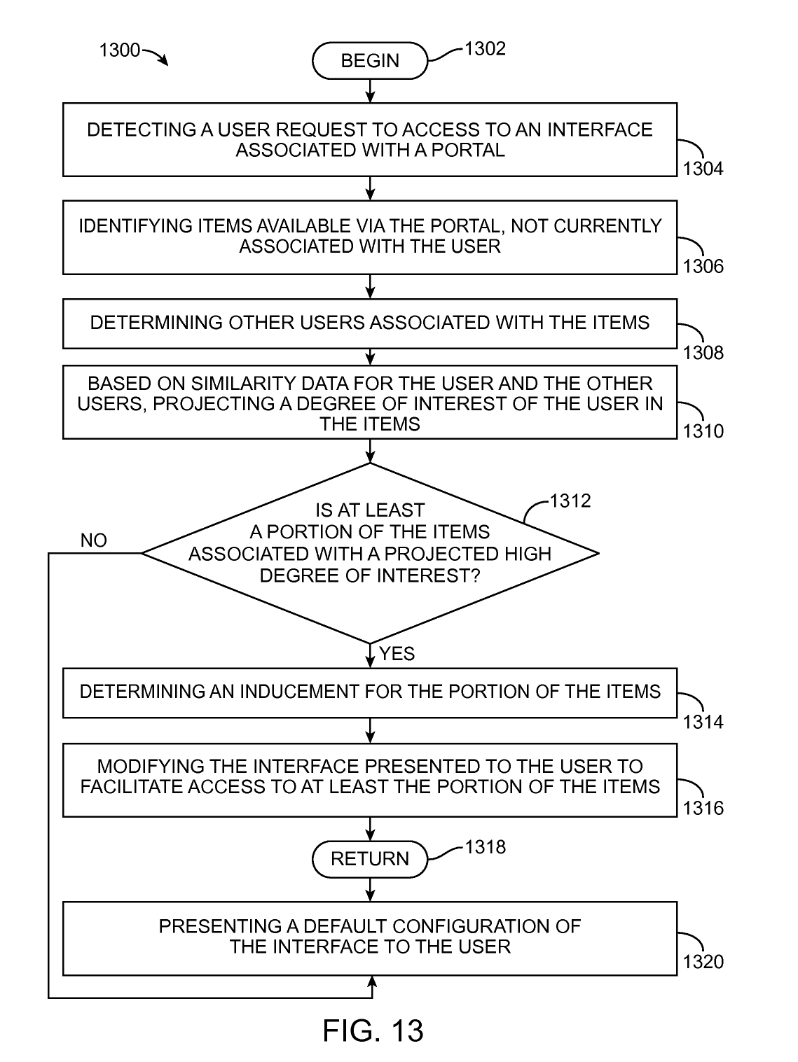

The methods described above generally assume that the items and associated inducements are known prior to any interactions with a user. However, the present technology is not limited in this regard. In other configurations, the items and inducements can be identified dynamically. One exemplary methodology is illustrated with respect to FIG. 13.

FIG. 13 is a flow chart of steps in an exemplary method for providing personalized offers to users, where the offers are generated dynamically. Method 1300 begins at step 1302 and proceeds to step 1304. At step 1304, a request from a user to access an interface associated with a portal is detected. For example, step 1304 can involve the user initializing an application associated with the portal. Alternatively, step 1304 can involve the user logging into a website or other interface associated with the portal. Additionally, any other communications between the user and the portal can also be interpreted as a request to access an interface of the portal.

Responsive to the detection at step 1304, the portal can identify items at step 1306 that are not currently associated with the user. Once such items are identified at step 1306, the method 1300 can proceed to step 1308 to begin the generating of the personalized offer. In particular, at step 1308, the portal can identify other users currently associated with the identified items. For example, the portal can identify all other users that have purchased the items identified at step 1306.

Once other users associated with the items are identified at step 1308, the method 1300 can proceed to step 1310. As step 1310, similarity data for the user and these other users is utilized to project the degree of interest of the user in the various items identified at step 1306. This can include computing a score, a ranking, or any other measure of the likely interest of each item to the user. This can be done, as previously with respect to FIGS. 5-10. Thereafter, if there is a high degree of interest in a portion of the items (1312), method 1300 proceeds to step 1314.

At step 1314, an inducement for the identified items associated with a high degree of interest can be computed. In such configuration, the inducement can be computed automatically in various ways. For example, in one configuration, inducements for particular items can be pre-defined. Some of these pre-defined inducements can be global. That is, the same inducement is used for any item, regardless of other factors. Alternatively, the pre-defined inducement can be individualized. That is, individual items can have a particular inducement pre-defined so that in the event that the item is specifically identified by the similarity data, the associated inducement is determined. In some instances, a combination of global and individualized inducements can be used. The present disclosure also contemplates that the inducements can be customized based on various factors. For example, inducements can be customized for particular users, particular devices, or based on any other factors pertinent to the portal or the user.

Once the inducements for the items to be offered to the user are determined at step 1314, the method can proceed to step 1316. At step 1316, the interface for the user can be modified to facilitate access to the portion of the items. For example, as described above with respect to FIGS. 2 and 3, interface elements can be added or modified to allow the user to view information regarding the items or purchase the items. The method 1300 can then proceed to step 1316 and resume previous processing at step 1318, including repeating and of the methods described herein. In the event that no items are projected to be of sufficiently high interest to the user at step 1310, the method can instead proceed to step 1320, where the default configuration for the interface is presented to the user. The method 1300 can then proceed to step 1318 and resume previous processing, including repeating and of the methods described herein.

Similarly as described above with respect to FIG. 4, the present technology contemplates that the interface resulting from method 1300 can be updated dynamically. However, in the case where the inducements are generated dynamically, additional types of adjustments of the interface are possible. For example, in some configurations, the user's behavior with respect to the modifications to the interface can be monitored. If the user's behavior fails to result in enticing the user with the current inducement, an improved inducement can be offered. For example, a deeper discount can be provided. Alternatively, the user's inaction over an extended period of time with respect to the inducement can be considered a lack of interest in the item. Accordingly, an inducement can expire on a per user basis so that although the inducement is continued to be offered to other users, the user will not be offered the inducement again, at least during a selected period of time.

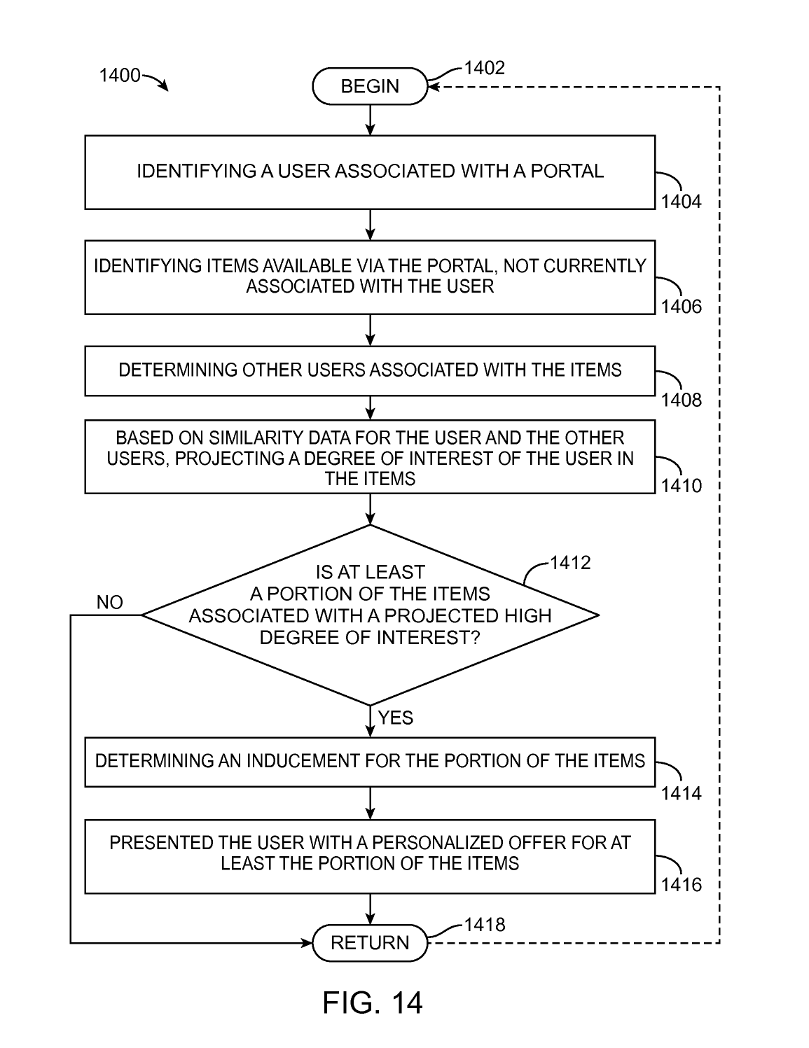

The preceding description assumes that the user will initiate the process that causes items and associated inducements to be presented to him. However, the present technology is not limited in this regard. Rather, the present disclosure contemplates that personalized offers can also be “pushed” to users associated with a portal. This is described below with respect to FIG. 14.

FIG. 14 is a flow chart of steps in an exemplary method 1400 for automatically presenting personalized offers to users. The method 1400 begins at step 1402 and proceeds to step 1404. At step 1404, a user associated with a portal is identified. That is, the portal can review its user records and identify a user therefrom to evaluate. Once the user is selected, the method can proceed with steps 1406, 1408, 1410, 1412, and 1414. These steps correspond substantially to steps 1306, 1308, 1310, 1312, and 1314, as discussed above with respect to FIG. 13.

After the inducements are determined at step 1414, the method can proceed to step 1416. At step 1416, a personalized offer is presented to the user. The personalized offer can be in the form of a message to the user based on contact information associated with the user. For example, the user can receive an email or a text message. The offer can simply identify the items and the associated inducements for the user. Alternatively, the offer can also include a means to facilitate access by the user to the items in the offer. For example, the delivered offer can include a link or other interface element that automatically directs the user to information regarding the items or that allows the user to purchase the items directly.

In an alternative configuration, the personalized offer can be delivered to an interface currently in use by the user. For example, if the user is already accessing an interface for the portal, responsive to the steps of method 1400 being performed, the presenting at 1416 can consist of modifying the interface. Thus, a user may initially launch an interface application for the portal using a default configuration. Offers can then be presented to the user upon execution of method 1400.

Regardless of how the offer is presented to the user, the method can then proceed from step 1416 to 1418 and resume previous processing. Also, in the event that no items are identified for a particular user at steps 1410 and 1412, the method can then proceed from step 1416 to 1418 and resume previous processing as well.

The present disclosure contemplates that method 1400 can be performed repeatedly, where the method is performed for a different user each time. However, the present disclosure also contemplates that method 1400 can be performed in parallel for multiple users. Further, method 1400 can be performed continuously. Thus, the offers for users can be updated over time.

As described above, the present disclosure often relies on user information associated with the portal. The present disclosure recognizes that the user information can potentially include personal information data. The present disclosure also recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the offers for users. For example, the system can reduce the number of times a user receives a given offer or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the portals, or publically available information.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method, comprising:
receiving a request from at least one user from a plurality of users associated with a portal to access an interface for the portal;
determining a portion of the plurality of users associated with a portion of a plurality of items currently associated with an inducement and available via the portal;
projecting a degree of interest for the at least one user in individual items from the portion of the plurality of items based on similarity data between the plurality of users; and
presenting the interface to the at least one user in a modified form that facilitates access to information regarding selected ones of the individual items from the portion, wherein the selected ones of the individual items are selected from ones of the individual items meeting a threshold criteria.

2. The method of claim 1, further comprising generating the similarity data, the generating comprising:
receiving data which comprises an identification of a plurality of items available via the portal and a portion of the plurality of users associated with each of the plurality of items;
determining an incidence of co-occurrence of pairs of individual ones of the plurality of items for different ones of the plurality of users; and
assigning a similarity rating between the pairs of individual ones of the plurality of items based on the determined incidence of co-occurrence for the plurality of users.

3. The method of claim 1, further comprising:
obtaining stored preference information associated with the at least one user, and
wherein the selected ones of the individual items are further selected from ones of the individual items meeting a preference criteria based on the stored preference information.

4. The method of claim 1, further comprising:
obtaining stored preference information associated with at least one type of user device; and
determining a type of user device associated with the at least one user,
wherein the selected ones of the individual items are further selected from ones of the individual items meeting a device criteria based on the stored preference information.

5. The method of claim 1, wherein the selected ones of the individual items exclude items already associated with the at least one user.

6. A system, comprising:
at least one processor;
a computer-readable medium having stored thereon a plurality of instructions for causing the at least one processor to perform the steps of:
identifying at least one user from a plurality of users associated with a portal;
determining a portion of the plurality of users associated with a portion of a plurality of items currently associated with an inducement and available via the portal;
projecting a degree of interest for the at least one user in individual items from the portion of the plurality of items based on similarity data between the plurality of users; and
presenting an interface to the at least one user that facilitates access to information regarding selected ones of the individual items from the portion, wherein the selected ones of the individual items are selected from ones of the individual items meeting a threshold criteria.

7. The system of claim 6, the computer-readable medium further comprising instructions for causing the at least one processor to perform the step of generating the similarity data, the generating comprising:
receiving data which comprises an identification of a plurality of items available via the portal and a portion of the plurality of users associated with each of the plurality of items;
determining an incidence of co-occurrence of pairs of individual ones of the plurality of items for different ones of the plurality of users; and
assigning a similarity rating between the pairs of individual ones of the plurality of items based on the determined incidence of co-occurrence for the plurality of users.

8. The system of claim 6, the computer-readable medium further comprising instructions for causing the at least one processor to perform the step of:
obtaining stored preference information associated with the at least one user, and
wherein the selected ones of the individual items are further selected from ones of the individual items meeting a preference criteria based on the stored preference information.

9. The system of claim 6, the computer-readable medium further comprising instructions for causing the at least one processor to perform the step of:
obtaining stored preference information associated with at least one type of user device; and
determining a type of user device associated with the at least one user,
wherein the selected ones of the individual items are further selected from ones of the individual items meeting a device criteria based on the stored preference information.

10. The system of claim 6, wherein the selected ones of the individual items exclude items already associated with the at least one user.

11. A non-transitory computer-readable medium having code for causing a computer to perform a method stored thereon, the method comprising:
receiving a request from at least one user from a plurality of users associated with a portal to access an interface for the portal;
identifying at least one item available from the portal and not currently associated with the at least one user;
determining a portion of the plurality of users associated with the at least one item;
projecting a degree of interest for the at least one user in the at least item based on similarity data between the plurality of users; and
responsive to the degree of interest meeting a threshold criteria, computing an inducement for the at least one item and presenting the interface to the at least one user in a modified form that facilitates access to information regarding the at least one item, the information comprising the inducement.

12. The computer-readable medium of claim 11, wherein the method further comprises generating the similarity data, the generating comprising:
receiving data which comprises an identification of a plurality of items available via the portal and a portion of the plurality of users associated with each of the plurality of items;
determining an incidence of co-occurrence of pairs of individual ones of the plurality of items for different ones of the plurality of users; and
assigning a similarity rating between the pairs of individual ones of the plurality of items based on the determined incidence of co-occurrence for the plurality of users.

13. The computer-readable medium of claim 11, wherein the inducement is a pre-defined inducement for the at least one item.

14. The computer-readable medium of claim 11, wherein if the at least one item was associated with a previous inducement for the user, the inducement is selected to be greater than the previous inducement.

15. The computer-readable medium of claim 11, wherein if the at least one item was associated with a previous inducement for the user, the information excludes the inducement.

16. A method, comprising:
identifying at least one user from a plurality of users associated with a portal;
determining a portion of the plurality of users associated with a portion of a plurality of items currently associated with an inducement and available via the portal;
projecting a degree of interest for the at least one user in individual items from the portion of the plurality of items based on similarity data between the plurality of users; and
delivering a message to the at least one user that facilitates access to information regarding selected ones of the individual items from the portion, wherein the selected ones of the individual items are selected from ones of the individual items meeting a threshold criteria.

17. The method of claim 16, further comprising generating the similarity data, the generating comprising:
receiving data which comprises an identification of a plurality of items available via the portal and a portion of the plurality of users associated with each of the plurality of items;
determining an incidence of co-occurrence of pairs of individual ones of the plurality of items for different ones of the plurality of users; and
assigning a similarity rating between the pairs of individual ones of the plurality of items based on the determined incidence of co-occurrence for the plurality of users.

18. The method of claim 16, further comprising:
obtaining stored preference information associated with the at least one user, and
wherein the selected ones of the individual items are further selected from ones of the individual items meeting a preference criteria based on the stored preference information.

19. The method of claim 16, further comprising:
obtaining stored preference information associated with at least one type of user device; and
determining a type of user device associated with the at least one user,
wherein the selected ones of the individual items are further selected from ones of the individual items meeting a device criteria based on the stored preference information.

20. A system, comprising:
at least one processor;
a computer-readable medium having stored thereon a plurality of instructions for causing the at least one processor to perform the steps of:
identifying a first portion of a plurality of users associated with at least one item available via a portal and a second portion of the plurality of user not associated with the at least one item;
associating an inducement with the at least one item;
selecting at least one user from the second portion based on a degree of interest in the at least one item obtained using similarity data for the plurality of users meeting a threshold criteria; and
delivering a communication to the at least one user that facilitates access to information regarding the at least one item.

21. The system of claim 20, further comprising a collaborative filter engine generating the similarity data, wherein the collaborative filter engine generates the similarity data based on:
receiving data which comprises an identification of a plurality of items available via the portal and a portion of the plurality of users associated with each of the plurality of items;
determining an incidence of co-occurrence of pairs of individual ones of the plurality of items for different ones of the plurality of users; and
assigning a similarity rating between the pairs of individual ones of the plurality of items based on the determined incidence of co-occurrence for the plurality of users.

22. The system of claim 20, the instructions further comprising accessing stored preference information, and wherein the delivering further comprises excluding from the communication information associated with any of the at least one item failing to correspond to the stored preference information.

23. The system of claim 20, the instructions further comprising accessing stored device information, and wherein the delivering further comprises preventing the communication from being deliver to any of the at least one user associated with a device failing to correspond to the stored device information.
